(19) United States
(12) Patent Application Publication
(10) Pub. No.: US 2004/0055645 A1
(43) Pub. Date: Mar. 25, 2004

(54) Flow-through pressure regulator including a housing with a press-fit closure member assembly

(75) Inventors: Brian Clay McIntyre, Suffolk, VA (US); James Archie Wynn JR., Virginia Beach, VA (US)

Correspondence Address: MORGAN LEWIS & BOCKIUS LLP, 1111 PENNSYLVANIA AVENUE NW, WASHINGTON, DC, 20004, US

(73) Assignee: Siemens VDO Automotive Corporation

(21) Appl. No.: 10/455,632

(22) Filed: Jun. 6, 2003

Related U.S. Application Data
(60) Provisional application No. 60/413,158, filed on Sep. 25, 2002.

(51) Int. Cl. F02M 69/54

(52) U.S. Cl. 137/508

(57) ABSTRACT

A flow-through pressure regulator including a divider that separates first and second chambers, a closure member, a housing, and a shell. The divider includes a passage that extends along an axis and provides fluid communication between the first and second chambers. The closure member moves relative to the divider between first and second configurations. The first configuration substantially prevents fluid communication through the passage, and the second configuration permits fluid communication through the passage. The housing includes first and second housing parts. The first housing part includes a fluid flow inlet and defines the first chamber, and the second housing part includes a fluid flow outlet and defines the second chamber. The shell defines a pocket that receives the closure member. And the shell is displaced along the longitudinal axis relative to the first housing part so as to be press fitted with respect to the first housing portion.

### FIELD OF THE INVENTION

A fuel pressure regulator relieves over-pressure in a fuel supply line between a fuel tank and an internal combustion engine. In particular, the fuel pressure regulator is responsible for supplying fuel, at or below a selected pressure, to a fuel injector of the internal combustion engine.

### BACKGROUND OF THE INVENTION

Most modern automotive fuel systems utilize fuel injectors to deliver fuel to the engine cylinders for combustion. The fuel injectors are mounted on a fuel rail to which fuel is supplied by a pump. The pressure at which the fuel is supplied to the fuel rail must be metered to ensure the proper operation of the fuel injectors. Metering is carried out using pressure regulators that control the pressure of the fuel in the system at all engine r.p.m. levels.

A known flow-through pressure regulator includes a separate closure member assembly that is staked to a housing. An example of such a known flow-through pressure regulator is shown in FIG. 4. In particular, a separate closure member assembly 10 is staked to a housing 20. The closure member assembly 10 includes a machined ball pocket 12, a spring 14, a ball 16, and a ball retainer 18.

It is believed that such a known flow-through pressure regulators suffer from a number of disadvantages including a manufacturing process that requires additional assembly operations as well as tooling to perform the staking. For example, in the known flow-through pressure regulator, the ball pocket is machined during a separate manufacturing step.

Thus, it is believed that there is a need to provide a flow-through pressure regulator that overcomes the disadvantages of the known flow-through pressure regulator.

### SUMMARY OF THE INVENTION

The present invention provides a flow-through pressure regulator including a divider that separates first and second chambers, a closure member, a housing, and a shell. The divider includes a passage that extends along an axis and provides fluid communication between the first and second chambers. The closure member moves relative to the divider between first and second configurations. The first configuration substantially prevents fluid communication through the passage, and the second configuration permits fluid communication through the passage. The housing includes first and second housing parts. The first housing part includes a fluid flow inlet and defines the first chamber, and the second housing part includes a fluid flow outlet and defines the second chamber. The shell defines a pocket that receives the closure member. And the shell is displaced along the longitudinal axis relative to the first housing part so as to be press fitted with respect to the first housing portion.

The present invention also provides a method of manufacturing a flow-through pressure regulator. The flow-through pressure regulator includes a closure member that cooperates with a divider to prevent a flow of fluid through the flow-through pressure regulator in a first configuration, and to permit the flow of fluid through the flow-through pressure regulator in a second configuration. The method includes forming a first housing part that defines a fluid flow inlet, forming a shell that defines a pocket adapted to receive a majority of the closure member, coupling the shell and first housing part, forming a second housing part that defines a fluid flow outlet, and coupling the first and second housing parts. The coupling the shell and first housing part includes press fitting the shell with respect to the first housing part, and the coupling the first and second housing parts sandwiches the divider between the first and second housing parts.

### BRIEF DESCRIPTION OF THE DRAWINGS

The accompanying drawings, which are incorporated herein and constitute part of this specification, illustrate presently preferred embodiments of the invention, and, together with the general description given above and the detailed description given below, serve to explain features of the invention.

FIG. 1 is a cross-section view of a flow-through pressure regulator according to a preferred embodiment that includes a closure member assembly that is integrated with a housing.

FIG. 2 is a cross-section views of a homogeneous shell for the flow-through pressure regulator shown in FIG. 1.

FIG. 3 is a group of detail views of a housing part for the flow-through pressure regulator shown in FIG. 1.

FIG. 4 is a partial cross-section view of a known flow-through pressure regulator including a separate closure member assembly that is staked to a housing assembly.

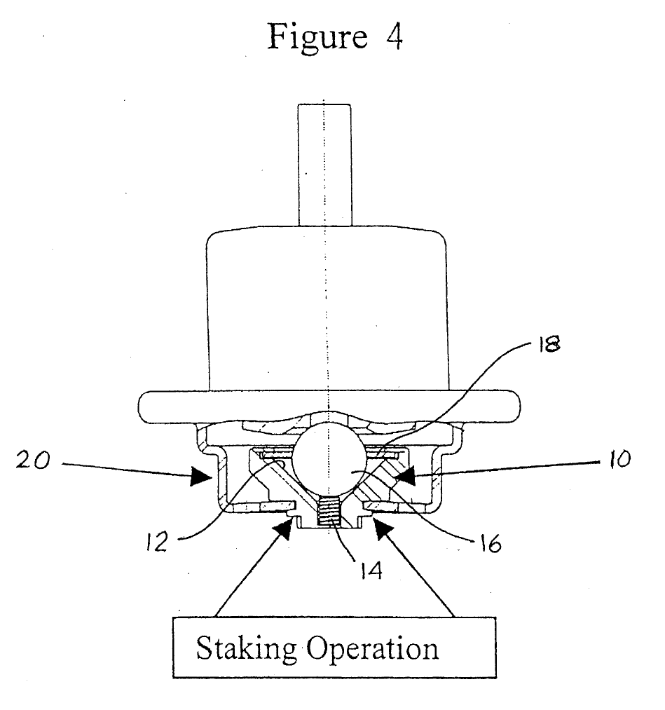

### DETAILED DESCRIPTION OF THE PREFERRED EMBODIMENT

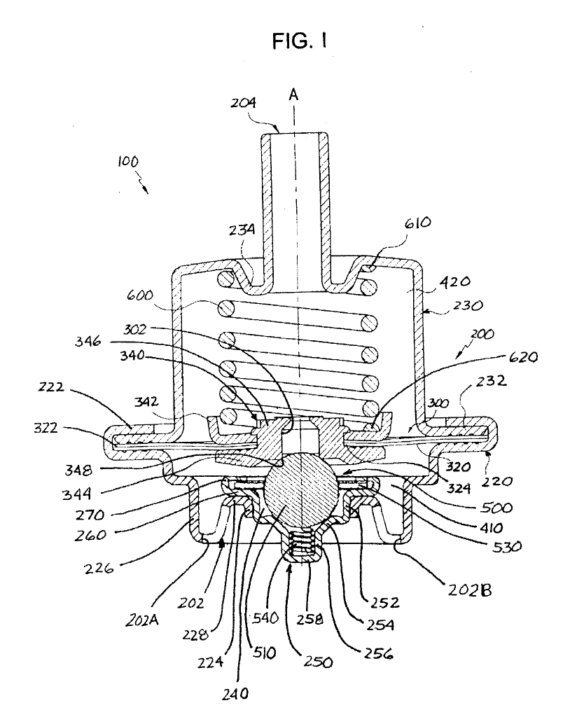

FIG. 1 shows a preferred embodiment of a flow-through pressure regulator 100, including a closure member assembly that is integrated with a housing, according to the present invention. The flow-through pressure regulator 100 includes a housing 200 defining an interior volume 400. The interior volume 400 of the housing 200 is separated by a divider 300 into a first chamber 410 and a second chamber 420. The divider 300 includes a passage 302 that provides fluid communication between the first and second chambers 410,420. A closure member 500 prevents or permits flow-through the passage 302.

The housing 200 has a fluid flow inlet 202 and a fluid flow outlet 204 spaced along a longitudinal axis A. The housing 200 can include a first housing part 220 and a second housing part 230 that are secured together to form the housing 200 that defines the interior volume 400. Preferably, the manner of securing includes crimping an annular flange 222 of the first housing portion 220 with an annular flange 232 of the second housing portion 230. Of course, other fastening techniques such as welding, soldering, adhering, etc. may also be used to fasten the first and second housing portions 220,230. The first housing portion 220 is shaped, preferably out of metal, in a single manufacturing operation, e.g., stamping. Of course, other materials and techniques may be used, including molding with a plastic material.

The fluid flow inlet 202 of the housing 200 is preferably located in the first housing portion 220, and the fluid flow outlet 204 of the housing 200 is preferably located in the second housing portion 230. The fluid flow inlet 202 can be a set of apertures (two apertures 202A,202B are shown) penetrating the first housing portion 220. The fluid flow outlet 204 can be a port penetrating the second housing portion 230.

The divider 300, which can include a diaphragm 320 and a seat 340, is suspended in the housing 200. Preferably, an outer perimeter 322 of the diaphragm 320 is sandwiched between the annular flanges 222,232 such that the divider 300 separates the interior volume 400 into the first and second chambers 410,420. Preferably, the flange 222 is rolled over the circumferential edge of the flange 232 and then preferably crimped, as discussed above, so as to form the housing 200 and at the same time secure the diaphragm 320 with respect to the housing 200.

A resilient calibrating element 600 biases the divider 300 against the closure member 500 at a predetermined force, which relates to the desired pressure at which the regulator 100 is to operate. The resilient calibrating element 600, which is preferably a coil spring, may be located in the second chamber 420 by a locator 234 on the second housing portion 230. The locator 234 may include a dimpled center portion that also provides the outlet 204. The locator 234 positions a first end 610 of the resilient calibrating element 600, while a second end 620 of the resilient calibrating element 600 is positioned with respect to the seat 340 by a seat retainer 342. According to a preferred embodiment, the seat retainer 342 is secured to the seat 340 such that an inner perimeter 324 of the diaphragm 320 is sandwiched between the seat 340 and the seat retainer 342.

The seat 340 is suspended in the housing 200 by the diaphragm 320 and provides the passage 302. Preferably, the passage 302 extends along the longitudinal axis A between a first seat portion 344 and a second seat portion 346. The first seat portion 344 is disposed in the first chamber 410 and the second seat portion 346 is disposed in the second chamber 420. The first seat portion 342 provides a seating surface 348 that cooperates with the closure member 500. In the manufacturing of the seat 340, the seating surface 348 is finished to assure a smooth sealing surface for the closure member 500.

Preferably, the closure member 500 includes a sphere 510 that is retained in a pocket 240 defined by a homogeneous shell 250. The homogeneous shell 250 includes a first cylindrical portion 252, a conical portion 254, a second cylindrical portion 256, an annular portion 260, and a deformable portion 270, all of which are preferably concentric about the longitudinal axis A. As it is used herein, the term “homogeneous” refers to a member that is formed completely from a single piece of material and therefore has material characteristics that are generally consistent throughout the entire member. As such, a homogeneous member according to the present invention incorporates a deformable portion that eliminates a separate retainer member that is necessary in a known flow-through pressure regulator to maintain the closure member within the pocket.

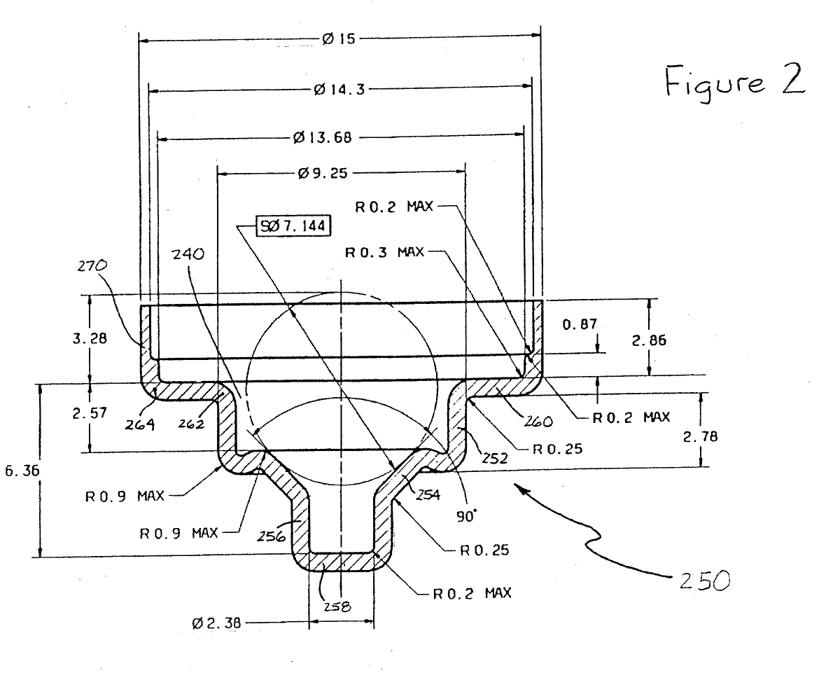

Referring additionally to FIG. 2, the annular portion 260 extends generally orthogonally with respect to the longitudinal axis A. An inner periphery 262 of the annular portion 260 is coupled to the first cylindrical portion 252, which is coupled via the conical portion 254 to the second cylindrical portion 256. The second cylindrical portion 256 and an endwall 258 occluding the second cylindrical portion 256 define a compartment that forms a portion of the pocket 240. The conical portion 254 can support the sphere 510, but does not prevent movement of the sphere 510.

An outer periphery 264 of the annular portion 260 is coupled to the deformable portion 270. Preferably, the deformable portion 270 is crimped or rolled-over a washer 530 of the closure member 500. Thus, the washer 530 is captured between the deformable portion 270 and the annular portion 260. The washer 530 has an inside diameter that is somewhat smaller than the diameter of the sphere ball 510 such that the sphere ball 510 cannot pass through the washer 530. In turn, the crimped or rolled-over deformable portion 270 has an inside diameter that is less than an outside diameter of the washer 530 such that the washer 530 cannot pass through the deformable portion 270 of the shell 250.

A resilient positioning element 540 biases the sphere 510 into engagement with the inside diameter of the washer 530. Preferably, the resilient positioning element 540 is a coil spring that is received in the compartment defined by the second cylindrical portion 256 and the endwall 258, and the inside diameter of the washer 530 includes a surface finish that provides smooth sliding contact with the sphere 510.

Thus, the homogeneous shell 250 defines the pocket 240, which receives the resilient positioning element 540, the washer 530 and a majority of the sphere 510. According to the present inventions, the shell 250 is displaced along the longitudinal axis A relative to the first housing part 220 so as to be press fitted with respect to the first housing portion 220.

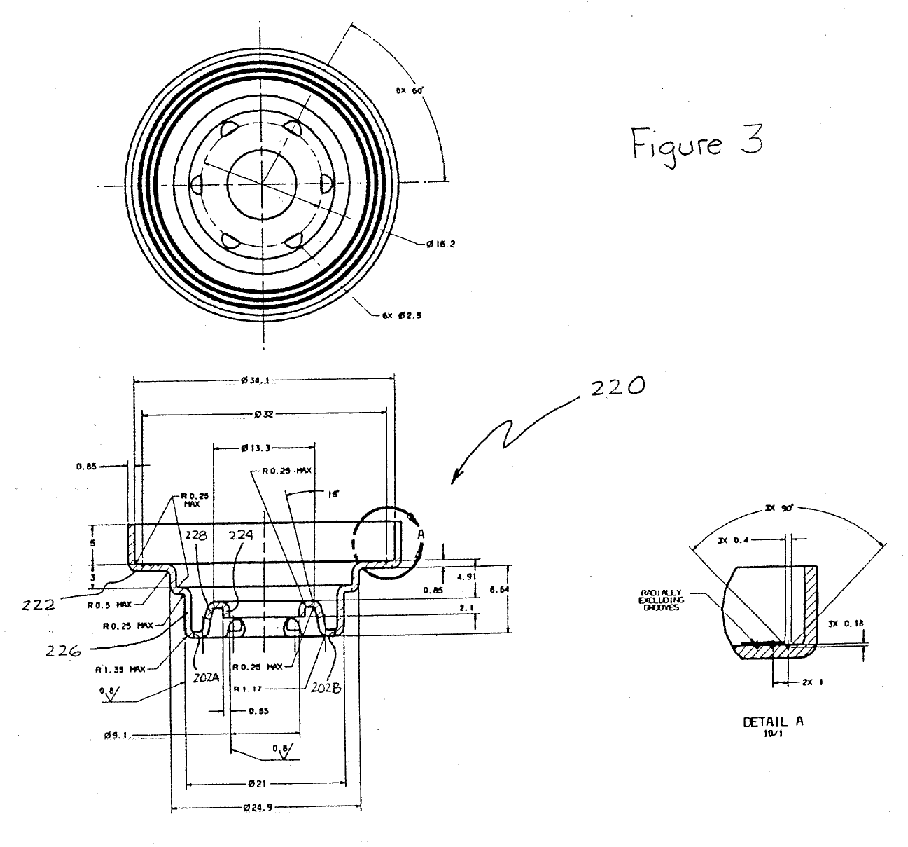

Referring additionally to FIG. 3, the first housing portion 220 includes a third cylindrical portion 224, a fourth cylindrical portion 226 and an intermediate portion 228 coupling the third and fourth cylindrical portions 224,226. Preferably, the third and fourth cylindrical portions 224,226, as well as the intermediate portion 228, are concentric about the longitudinal axis A. Preferably, the intermediate portion 228 is penetrated by the set of apertures 202A,202B that define the fluid flow inlet 202 of the housing 200. Preferably, the first cylindrical portion 252 is press fit with respect to the third cylindrical portion 224 so as to establish a fluid tight connection between the shell 250 and the first housing part 220. The fourth cylindrical portion 226 may be press fitted into a mating socket (not shown) of a system for regulating fuel pressure.

Preferably, the first housing portion 220 and the shell 250 are formed out of metal in a single stamping operations. Of course, other materials and techniques may be used, including molding out of a plastic material.

FIGS. 2 and 3 show one set of preferred dimensions for the shell 250 and the first housing portion 220, respectively.

One method of assembling the pressure regulator 100 is to 1) form, e.g., stamp, the first housing portion 220, the shell 250 and the second housing portion 280, 2) install the closure member 500 in the pocket 240 of the shell 250 (the sub-assembly of which is described in greater detail hereinafter), 3) press fit the shell 250 into the first chamber 410 of the first housing portion 220, 4) install the resilient calibrating element 600 in the second chamber 420 of the second housing portion 230, 5) assemble the divider 300, and 6) assemble the first and second housing portions 220,230, including sandwiching the outer perimeter 322 of the divider 300 between the first and second flanges 222,232. According to the present invention, at least the shell 250 is formed from a single homogeneous member, e.g., a metal sheet.

Preferably, the closure member 500 is installed in the shell 250 by 1) installing the resilient positioning element 540 in the compartment defined by the second cylindrical portion 256 and the endwall 258; 2) installing the sphere 510 in the pocket 240; 3) installing the washer 530 over the sphere 510; and 4) crimping or rolling-over the deformable portion 270 so that the washer 530 is captured between the annular and deformable portions 260,270 of the shell 250. Preferably, the washer 530 is captured loosely between the annular and deformable portions 260,270 such that it may float, e.g., is allowed a limited amount of longitudinal and radial motion with respect to the axis A. By virtue of being able to float, the washer 530 permits the sphere 510, under the bias of the resilient positioning element 540, to align with respect to the seating surface 348.

Preferably, the divider 300 is assembled by installing the inner perimeter 324 of the diaphragm 320 on the seat 340, so as to surround the passage 302, and press fitting the seat retainer 342 onto the seat 340 so as to sealingly sandwich therebetween the inner perimeter 324.

The resilient calibrating element 600 is installed in the second housing portion 230. Preferably, the first end 610 of the resilient calibrating element 600 is positioned with respect to the locator 234 of the second housing portion 230, and the second end 620 of the resilient calibrating element 600 is positioned with respect to the seat retainer 342.

The first and second housing portions 220,230 are then matingly engaged. Preferably, the flange 222 of the first housing portion 220 is abutted against the flange 232 of the second housing portion 230, and the flange 222 is crimped around the flange 232. Of course, the flange 232 may alternatively be crimped around the flange 222, or another coupling technique, e.g., welding or adhering, may be used to secure the first and second housing portions 220,230 with respect to one another.

The operation of the flow-through pressure regulator in a fuel system will now be described. The resilient calibrating element 600 acts through the seat retainer 342 to bias the divider 300 toward the closure member 500. The resilient positioning element 540 biases the sphere 510 against the seating surface 348 of the seat 340. In a first configuration, the sphere 510 is seated against surface 348 so as to prevent a flow of fuel through the pressure regulator 100.

Fuel enters the regulator 100 through apertures 202A,202B and exerts pressure on the divider 300. When the force of the fuel pressure acting on the divider 300 is greater than the force exerted by the resilient calibrating element 600, the diaphragm 320 flexes so as to allow the seat 340 to move along the longitudinal axis A, and the sphere 510 separates from the seating surface 348 of the seat 340. This is a second configuration that permits the flow of fuel through inlet 202, into the first chamber 410, between the sphere 510 and the seat 340, through the passage 302 into the second chamber 420, and through the outlet 204. Selection of the resilient calibrating element 600, and more particularly the force exerted by the resilient calibrating element 600 on the divider 300, determines the fuel pressure level at which pressure regulation, i.e., the transition between the first and second configurations, occurs in the pressure regulator 100.

A closure member assembly that is assembled into a homogeneous shell, according to the present invention, allows the resilient positioning element, the sphere, and the washer to be captured without a separate retainer assembly for the closure member, and eliminates an additional piece and assembly step.

A shell that is press-fit into a housing, according to the present invention, eliminates the need to machine a ball pocket, as well as the staking operations that were necessary in known flow-through pressure regulators. Thus, the present invention simplifies the manufacture and provides a more cost-effective way of assembling a flow-through pressure regulator.

While the invention has been disclosed with reference to certain preferred embodiments, numerous modifications, alterations, and changes to the described embodiments are possible without departing from the sphere and scope of the invention, as defined in the appended claims and their equivalents thereof. Accordingly, it is intended that the invention not be limited to the described embodiments, but that it have the full scope defined by the language of the following claims.

What is claimed is:

1. A flow-through pressure regulator, comprising:
a divider separating first and second chambers, the divider including a passage extending along an axis and providing fluid communication between the first and second chambers;
a closure member moving relative to the divider between first and second configurations, the first configuration substantially preventing fluid communication through the passage, and the second configuration permitting fluid communication through the passage; and
a housing including:
a first housing part including a fluid flow inlet and defining the first chamber; and
a second housing part including a fluid flow outlet and defining the second chamber; and
a shell defining a pocket receiving the closure member, the shell being displaced along the longitudinal axis relative to the first housing part so as to be press fitted with respect to the first housing portion.

2. The flow-through pressure regulator of claim 1, wherein the divider comprises a seat, the seat being suspended by the divider in the housing and defining the passage, the seat having first and second seat portions spaced along the longitudinal axis, the first seat portion being disposed in the first chamber, and the second seat portion being disposed in the second chamber.

3. The flow-through pressure regulator of claim 2, wherein the first configuration comprises the closure member engaging the first seat portion, and the second configuration comprises the closure member being spaced from the first seat portion.

4. The flow-through pressure regulator of claim 2, wherein the divider comprises a diaphragm suspending the seat with respect to the housing.

5. The flow-through pressure regulator of claim 4, wherein the diaphragm comprises a flexible annular member.

6. The flow-through pressure regulator of claim 4, wherein the diaphragm comprises a first perimeter sandwiched between the first and second housing portions.

7. The flow-through pressure regulator of claim 6, wherein the diaphragm comprises a second perimeter being secured to the seat, and the passage extending through the second perimeter.

8. The flow-through pressure regulator of claim 1, wherein the closure member comprises a sphere.

9. The flow-through pressure regulator of claim 1, wherein the closure member is movable along the longitudinal axis relative to the shell.

10. The flow-through pressure regulator of claim 9, comprising:
a resilient element biasing the closure member from the shell and toward the divider.

11. The flow-through pressure regulator of claim 1, wherein the shell comprises an annular portion and a deformable portion, the annular portion extends generally orthogonally with respect to the longitudinal axis, the deformable portion is coupled to the annular portion.

12. The flow-through pressure regulator of claim 11, comprising:
a washer engaging the closure member and being captured between the deformable portion of the shell and an annular portion of the shell so as to retain a majority of the closure member in the pocket.

13. The flow-through pressure regulator of claim 11, wherein the shell comprises a first cylindrical portion being press fitted with respect to the first housing portion, a second cylindrical portion including an endwall supporting a resilient element biasing the closure member with respect to the shell, and a conical portion connecting the first and second cylindrical portions, the conical portion receiving the majority of the closure member.

14. The flow-through pressure regulator of claim 13, wherein the first housing part comprises third cylindrical portion, a fourth cylindrical portion, and an intermediate portion between the third and fourth cylindrical portions, the third cylindrical portion is press fitted with respect to the first cylindrical portion of the shell, and the third and fourth cylindrical portions are generally concentric about the longitudinal axis.

15. The flow-through pressure regulator of claim 14, wherein a set of apertures define the fluid flow inlet, and the set of apertures penetrate the intermediate portion of the first housing part.

16. The flow-through pressure regulator of claim 14, wherein the first cylindrical, conical, and second cylindrical portions and are generally concentric about the longitudinal axis.

17. The flow-through pressure regulator of claim 13, wherein the endwall occludes the first cylindrical portion, and the endwall is generally centered about the longitudinal axis.

18. A method of manufacturing a flow-through pressure regulator, the flow-through pressure regulator including a closure member cooperating with a divider to prevent a flow of fluid through the flow-through pressure regulator in a first configuration and to permit the flow of fluid through the flow-through pressure regulator in a second configuration, the method comprising:
forming a first housing part defining a fluid flow inlet;
forming a shell defining a pocket adapted to receive a majority of the closure member;
coupling the shell and first housing part, the coupling the shell and first housing part including press fitting the shell with respect to the first housing part;
forming a second housing part defining a fluid flow outlet; and
coupling the first and second housing parts, the coupling the first and second housing parts being adapted to sandwich the divider between the first and second housing parts.

19. The method of claim 18, wherein the forming the shell comprises forming first and second cylindrical portions concentrically about a longitudinal axis, and forming a conical portion connecting the first and second cylindrical portions.

20. The method of claim 19, wherein the forming the first housing part comprises forming third and fourth cylindrical portions concentrically about the longitudinal axis.

21. The method of claim 20, wherein the forming the first housing part comprises forming and intermediate portion connecting the first and fourth cylindrical portions, and comprises forming a set of apertures penetrating the intermediate portion, the set of apertures defining the fluid flow inlet.

22. The method of claim 20, wherein the coupling the shell and first housing part comprises press fitting the first cylindrical portion with respect to the third cylindrical portion.

23. The method of claim 18, wherein the forming the shell comprises crimping a deformable portion of the shell so as to retain in the pocket the majority of the closure member in the pocket.

24. The method according to claim 18, wherein the forming the first housing part comprises forming a first annular flange, the forming the second housing part comprises forming a second annular flange, and the coupling the first and second housing parts comprises matingly engaging the first and second annular flanges.

25. The method according to claim 18, wherein the forming the shell comprises one of stamping a single homogeneous sheet metal member and molding a single homogeneous plastic member.
